(19) United States
(12) Patent Application Publication
(10) Pub. No.: US 2024/0207920 A1
(43) Pub. Date: Jun. 27, 2024

(54) FORMING AND MANUFACTURING METHOD OF BICYCLE SHOCK-ABSORBING FRONT FORK CROWN

(71) Applicant: ALEX GLOBAL TECHNOLOGY, INC., TAINAN CITY (TW)

(72) Inventor: WEI-CHIN CHEN, TAINAN CITY (TW)

(21) Appl. No.: 18/087,594

(22) Filed: Dec. 22, 2022

(51) Int. Cl. B21D 53/86; B21D 22/02; B21D 22/26; B21D 31/00

(52) U.S. Cl. CPC B21D 53/86; B21D 22/02; B21D 22/26; B21D 31/00; B62K 21/04

(57) ABSTRACT

The present invention relates to a forming and manufacturing method of a bicycle shock-absorbing front fork crown. It mainly includes a stamping step that processes and forms an aluminum ingot base material into a crown prototype, wherein the crown prototype includes two shoulders and a solid convex seat, a deep drawing forming step that the solid convex seat is extended and processed to form a front fork tube, an appearance processing step that the front fork crown is formed through processing and forming the two side shoulders and the front fork tube surface, and finally, a drilling process is carried out on the two side shoulders. In this way, the front fork crown with the front fork tube can be formed integrally with an aluminum ingot through a series of processing processes, so that the front fork crown can provide a high-strength anti-vibration function.

### BACKGROUND OF THE PRESENT INVENTION

### Field of the Invention

The present invention relates to a forming and manufacturing of a bicycle shock-absorbing front fork crown, and in particular to an application invention of a technology of integrally forming a crown of a front fork tube.

### Description of Related Art

It is noted that as the public gradually attaches importance to the life of both health and entertainment, it is becoming more and more common to achieve the purpose of exercising and leisure by riding bicycle. In order to increase the safety of riding, a bicycle, whether it is a high-end bicycle suitable for mountain climbing or racing, or a low-end bicycle only for leisure and entertainment, generally has a suspension mechanism (shock absorber). The suspension mechanism primarily provides the bicycle with cushioning against impacts, vibrations, or other disturbances experienced while the vehicle is in motion. The suspension mechanism can be installed in the front wheel, the rear wheel or in other locations such as a seat post or handlebars to slow down or absorb the externally generated external forces.

The design of bicycles has developed various functions in response to the riding needs of various occasions. For example, in order to provide suspension and shock absorption functions for bicycles, a shock absorber structure may be installed on the front fork to form a shock absorber front fork. Suspension front forks like this generally consist of a front fork tube inserted in the center of a bridge-shaped fork shoulder at the end, a displaceable travel tube connected with each end of the fork shoulder, and a shock absorber damper installed at the end of the travel tube. When the front wheel is bumpy on the road surface, the front fork is compressed by force, and the stroke tube moves downward along the outer tube. After the shock is absorbed by the shock absorber damper, the bridge fork shoulder and the front fork tube will also receive the force of the rider's depression, torsion and feedback from the shock absorber. Accordingly, this part is subjected to various external forces, and when the front fork tube is installed on the bridge-shaped fork shoulder by inserting and assembling, it is obviously insufficient in strength, which may be prone to deformation or fracture, rendering safety threats.

### SUMMARY OF THE PRESENT INVENTION

A main object of the present invention is to provide a forming and manufacturing method of a bicycle shock-absorbing front fork crown, especially a technology for integrally forming a crown of a front fork tube.

Main objects and effects of the forming and manufacturing method of the bicycle shock-absorbing front fork crown of the present invention can be achieved by the following specific technical means:

It mainly applies a stamping step that processes and forming an aluminum ingot base material into a crown prototype, wherein the crown prototype includes two shoulders and a solid convex seat, a deep drawing forming step that the solid convex seat is extended and processed to form a front fork tube, an appearance processing step that the front fork crown is formed through processing and forming the two side shoulders and the front fork tube surface, and finally, a drilling process is carried out on the two shoulders. In this way, the front fork crown with the front fork tube can be formed integrally with an aluminum ingot through a series of processing processes, so that when the front wheel of the bike body is subjected to an external force impact, the front fork crown can provide a high-strength anti-vibration function.

According to a preferred embodiment of the forming and manufacturing method of bicycle shock-absorbing front fork crown provided by the present invention, the front fork crown mainly includes two shoulders and a front fork tube integrally formed between the two shoulders, wherein the front fork tube has an inner tube diameter of a predetermined depth, wherein the shoulders respectively have an assembly hole for assembling the shock-absorbing damping device, and the two shoulders form an arched concave portion corresponding with the front fork tube.

### BRIEF DESCRIPTION OF THE DRAWINGS

FIG. 1 is a flow diagram of the present invention.

FIG. 2 is a plane flow diagram of the present invention.

FIG. 3 is a perspective view of an aluminum ingot base material according to the present invention.

FIG. 4 is a perspective view of stamping crown prototype according to the present invention.

FIG. 5 is a perspective view of a deep drawn front fork tube according to the present invention.

FIG. 6 is a perspective view of contour processing according to the present invention.

FIG. 7 is a perspective view of the shoulder drilling according to the present invention.

### DETAILED DESCRIPTION OF THE PREFERRED EMBODIMENT

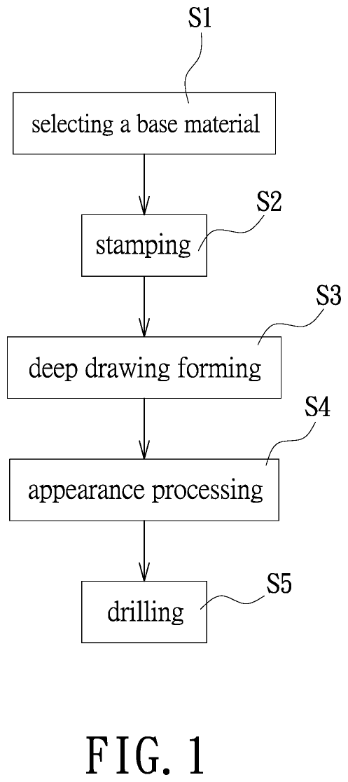

First, the actual application technology and means of the present invention are used, and referring to FIG. 1, a flow diagram of the forming and manufacturing method of the bicycle shock-absorbing front fork crown of the present invention is illustrated, wherein the steps are as follows:
S1) selecting a base material: selecting an aluminum ingot as a base material;
S2) stamping: forming a crown prototype (2) by stamping the aluminum ingot base material (1), wherein the crown prototype (2) has two side shoulders (21), and an upwardly extending solid convex seat (22) and a downward concave portion (23) are formed between the two side shoulders (21);
S3) deep drawing forming: deep pressing and extending the solid convex seat (22) longitudinally, allowing the solid convex seat (22) to gradually transfer and form a front fork tube (31), which has a pipe side wall;
S4) appearance processing: surface processing the aluminum ingot base material (1) after the above mentioned deep drawing forming, so that the shoulders (21) are formed into a predetermined appearance;
S5) drilling: drilling centers of the two shoulders (21) respectively to form an assembly hole (32) for assembling the shock-absorbing damping device, so as to obtain a front fork crown (3).

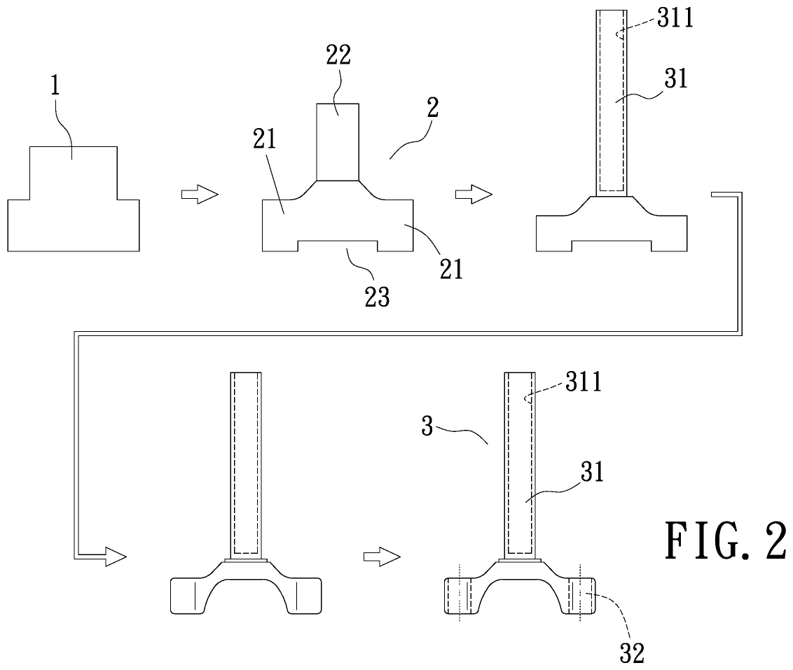

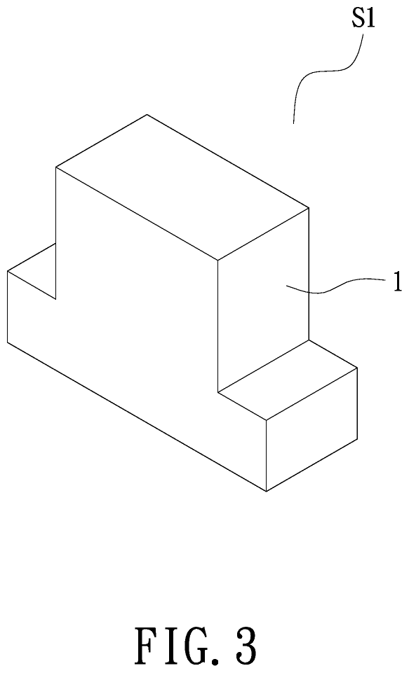

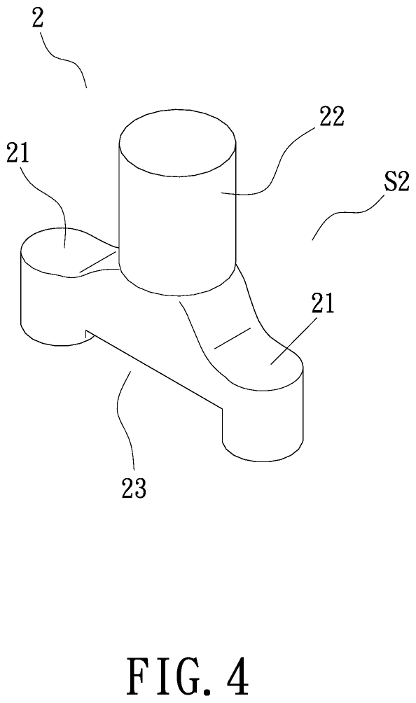

Refer to FIGS. 1 to 7, when it is actually implemented, the step (S1) of selecting the base material is performed first, to select an aluminum ingot as the base material (as shown in FIG. 3), wherein the aluminum ingot is made of aluminum alloy, which has the advantages of light weight, good strength, and etc. Generally, aluminum alloys can be composed of silicon (Si), copper (Cu), magnesium (Mg), iron (Fe), nickel (Ni), manganese (Mn), zinc (Zn), chromium (Cr), titanium (Ti), and etc., and can be selected according to the required performance. The aluminum ingot base material (1) selected in the present invention is roughly as illustrated in the figure, and then the stamping step (S2) is applied to the aluminum ingot base material (1), wherein a crown prototype (2) is formed by stamping the aluminum ingot base material (1), wherein the crown prototype (2) has two side shoulders (21), wherein an upwardly extending solid convex seat (22) and a downwardly concave portion (23) are formed between the two side shoulders (21), as illustrated in FIG. 4.

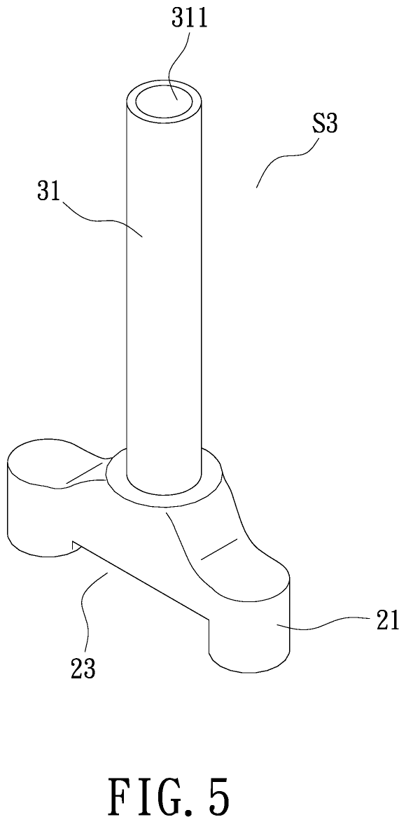

Then, the crown prototype (2) is subjected to the deep drawing forming step (S3), and is stretched at the solid convex seat (22) through a mold deep pressure, so that the aluminum ingot material of the solid convex seat (22) extends longitudinally, and the material of the solid convex seat (22) is gradually transformed to form the pipe side wall, thereby integrally forming the front fork tube (31) on the crown prototype (2), as illustrated in FIG. 5, wherein the front fork tube (31) has an inner tube diameter (311) with a predetermined depth, and the front fork tube (31) is allowed to be used for assembly of a bicycle frame and correspondingly assembled with a handlebar.

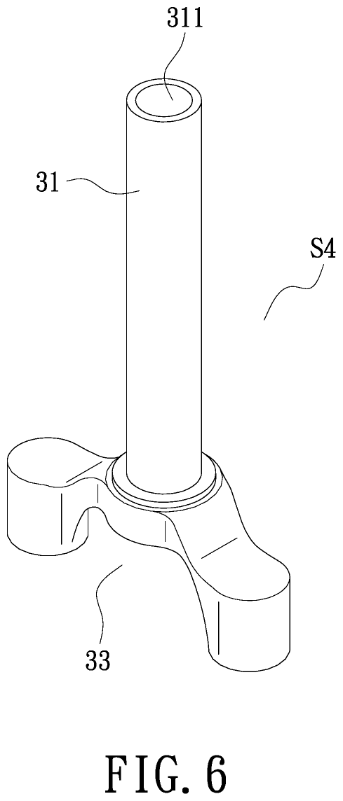

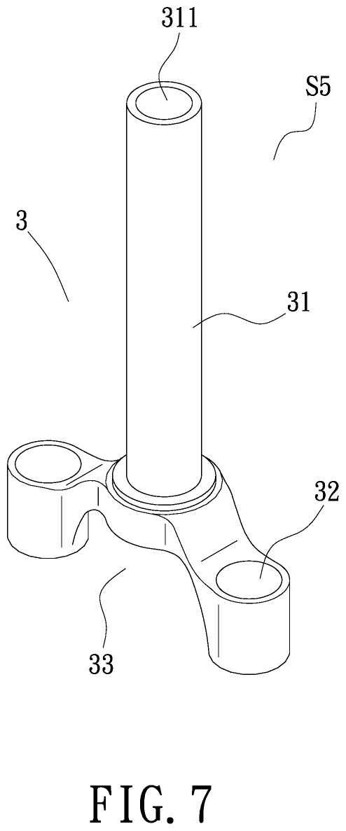

After the solid convex seat (22) of the crown prototype (2) is formed into the front fork tube (31), the previously processed aluminum ingot base material (1) is then subjected to the appearance processing step (S4) to form the two shoulders (21) into a predetermined appearance, as illustrated in FIG. 6, wherein this appearance is processed according to the requirements, wherein an arched concave portion (33) is formed at the place where the two shoulders (21) correspond to the front fork tube (31), generally by stamping, gradually stamping the appearance to form a desired shape. Finally, the drilling step (S5) is carried out at the center of the two shoulders (21), so that the shoulders (21) are respectively provided with an assembly hole (32) for assembling the shock-absorbing damping device, as illustrated in FIG. 7, so as to finally obtain a front fork crown (3).

The front fork crown (3) made by means of the above forming and manufacturing method includes two shoulders (21) and a front fork tube (31) integrally formed between the two shoulders (21), wherein the front fork tube (31) has an inner tube diameter (311) with a predetermined depth, wherein the shoulders (21) respectively have an assembly hole (32) for assembling a shock-absorbing damping device, wherein an arched concave portion (33) is formed between the two shoulders (21) correspond to the front fork tube (31), as illustrated in FIG. 7. Thereby, through a series of processing processes, the aluminum ingot can be integrally formed into a front fork crown (3) with the front fork tube (31), when the front wheel of a bike body is subjected to an external impact, the front fork crown (3) will be capable of providing a high-strength anti-vibration function.

Compared with the conventional structure, advantages and effects provided by the present invention include the following:
1. The forming and manufacturing method of the bicycle shock-absorbing front fork crown of the present invention allows the aluminum ingot to integrally form the front fork crown with the front fork tube through a series of processes, so that when the front wheel of the bike body is subjected to external force impact, the front fork crown is capable of providing a high-strength anti-shock function.
2. The forming and manufacturing method of the bicycle shock-absorbing front fork crown of the present invention can save the processing costs and assembly time of separately manufacturing the head tube through integral molding, which is economic.

What is claimed is:

1. A forming and manufacturing method of bicycle shock-absorbing front fork crown, comprising the steps of:
S1) selecting a base material: selecting an aluminum ingot as a base material;
S2) stamping: forming a crown prototype by stamping the aluminum ingot base material, wherein the crown prototype has two side shoulders, and an upwardly extending solid convex seat and a downward concave portion are formed between the two side shoulders;
S3) deep drawing forming: deep pressing and extending the solid convex seat longitudinally, allowing the solid convex seat to gradually transfer and form a front fork tube, which has a pipe side wall;
S4) appearance processing: surface processing the aluminum ingot base material after the above mentioned deep drawing forming, so that the shoulders are formed into a predetermined appearance;
S5) drilling: drilling centers of the two shoulders respectively to form an assembly hole respectively, so as to obtain a front fork crown.

2. The forming and manufacturing method as claimed in claim 1, wherein the appearance processing step (S4) forms a predetermined appearance through stamping.
